(19) United States
(12) Patent Application Publication
(10) Pub. No.: US 2016/0338273 A1
(43) Pub. Date: Nov. 24, 2016

(54) WATERING ASSEMBLY

(71) Applicant: Waterpulse, Inc, Longmont, CO (US)

(72) Inventors: Ronald Johnson, San Jose, CA (US); Mark Bigham, Campbell, CA (US); Yugen Lockhart, Palo Alto, CA (US); Idriss Mansouri-Ruiz, San Jose, CA (US)

(21) Appl. No.: 14/716,485

(22) Filed: May 19, 2015

(51) Int. Cl. A01G 25/02; F16M 13/02; F16B 2/22; A01G 27/00

(52) U.S. Cl. CPC A01G 25/023; A01G 27/008; F16M 13/02; F16B 2/22

(57) ABSTRACT

An integrated clip and injector assembly comprises a clip for securing a watering area such as a watering mat in place and an injector clip for securely holding an emitter configured to deliver an adjustable quantity of water to the area. The securing clip comprises a clip for clipping to a mat and one or more mounting features for attaching the clip and the mat to an additional object. The injector clip holds the emitter at a location on the mat so that water is delivered to the desired area. The amount of water delivered to the area is adjusted by a flow restrictor.

### FIELD OF THE INVENTION

This invention relates to systems for delivering water to plants and soil. More particularly, this invention relates to an integrated clip and injector assembly for securing and delivering water to an area.

### BACKGROUND OF THE INVENTION

Irrigation systems are used in order to artificially apply water to an area where it is needed but not necessarily present. Automated and semi-automated irrigation systems enable areas of agriculture, landscaping and planting to be watered with little effort after the system is configured to deliver a necessary amount of water at a specified time. One key to an effective system is to get as much water and nutrients to the area as possible without over watering. However, irrigation water is often lost due to evaporation and decreased contact with the desired area as the water is sprayed over a large distance. Water may also be lost if the watering area or plants to be watered are inadvertently moved before or during watering. Placing an irrigation outlet closer to the desired point of watering enables the system to better monitor the amount of distributed water and consequently increases the efficiency of the system by reducing the amount of water lost from evaporation and over watering. Further, anchoring the watering area in place also ensures that the watering area and plants to be watered do not move and receive the required amount of moisture.

### SUMMARY OF THE INVENTION

An integrated clip and injector assembly comprises a clip for securing a watering area such as a watering mat in place and an injector clip for securely holding an emitter configured to deliver an adjustable quantity of water to the area. The securing clip comprises a clip for clipping to a mat or watering area and one or more mounting features for attaching the clip and the mat to an additional object. The injector clip holds the emitter at a location on the mat so that water is delivered to the desired area. The amount of water delivered to the area is adjusted by a flow restrictor.

In one aspect, a mounting clip for a watering mat comprises a clip body for clipping to the watering mat and comprising a top, a bottom, and a side wall connecting the top and the bottom and one or more mounting features for mounting the clip to an object. In some embodiments, the side wall comprises a curved surface between the top and the bottom. The object is able to comprise one of a table, the ground, and a surface for holding the watering mat. In some embodiments, the clip comprises a hook feature for securing the clip body to the watering mat. In some embodiments, the one or more mounting features comprise one or more mounting holes. In some of these embodiments, the one or mounting holes are configured to receive one or more of a screw, a nail, and a zip-tie. The top comprises a smooth low profile top which is mounted flush with a top of the watering mat.

In another aspect, an injector device for a watering assembly comprises a snap jaw for releasably receiving an emitter body and a clip for clipping the injector device to a watering area. In some embodiments, the snap jaw comprises one or more teeth for securing the emitter body. In some of these embodiments, the snap jaw comprises a torque key for preventing the emitter body from twisting. A hood is able to protect an injector tube of the emitter body. In some embodiments, the watering area comprises a first watering mat. In some embodiments, the injector device comprises a rear hook feature for securing the injector device to a second watering mat. The emitter body is reversible within the snap jaw.

In a further aspect, an emitter assembly comprises a housing and an adjustable water flow restrictor received within the housing. In some embodiments, the adjustable flow restrictor is secured within the housing by a clip. In some embodiments, the adjustable flow restrictor comprises a tapered flow segment. The adjustable flow restrictor is able to comprise a helical flow path. In some embodiments, the adjustable flow restrictor is axially movable with respect to the housing in order to adjust a flow path. The emitter assembly is able to be releasably received by an injector device. The emitter assembly comprises interlocking geometry to match the injector device.

### BRIEF DESCRIPTION OF THE DRAWINGS

FIGS. 1A and 1B illustrate a mounting clip for a watering mat in accordance with some embodiments.

FIG. 2 illustrates an injector clip in accordance with some embodiments.

FIGS. 3A and 3B illustrate an injector clip and emitter assembly in accordance with some embodiments.

FIG. 4 illustrates an emitter assembly in accordance with some embodiments.

FIG. 5A illustrates a flow restrictor for an emitter assembly in accordance with some embodiments.

FIGS. 5B-5C illustrate a close-up view of a flow segment of a flow restrictor in accordance with some embodiments.

FIG. 6 illustrates a housing for an emitter assembly in accordance with some embodiments.

FIG. 7 illustrates a watering assembly in accordance with some embodiments.

FIG. 8 illustrates a method of watering an area in accordance with some embodiments.

### DETAILED DESCRIPTION OF THE INVENTION

In the following description, numerous details are set forth for purpose of explanation. However, one of ordinary skill in the art will realize that the invention may be practiced without the use of these specific details or with equivalent alternatives. Thus, the presently claimed invention is not intended to be limited to the embodiments shown but is to be accorded the widest scope consistent with the principles and features described herein. Throughout the description similar components are similarly marked in order to aid comprehension.

Embodiments are directed to an integrated clip and injector assembly for an irrigation system. The integrated clip and injector assembly comprises a clip for securing a watering area such as a watering mat and an injector clip for securely holding an emitter configured to deliver an adjustable quantity of water to the area. The securing clip comprises a clip for clipping to a mat or watering area and one or more mounting features for attaching the clip and the mat to an additional object. The injector clip holds the emitter at a location on the mat so that water is delivered to a desired area. The amount of water delivered to the area is adjustable between a high flow and a low flow.

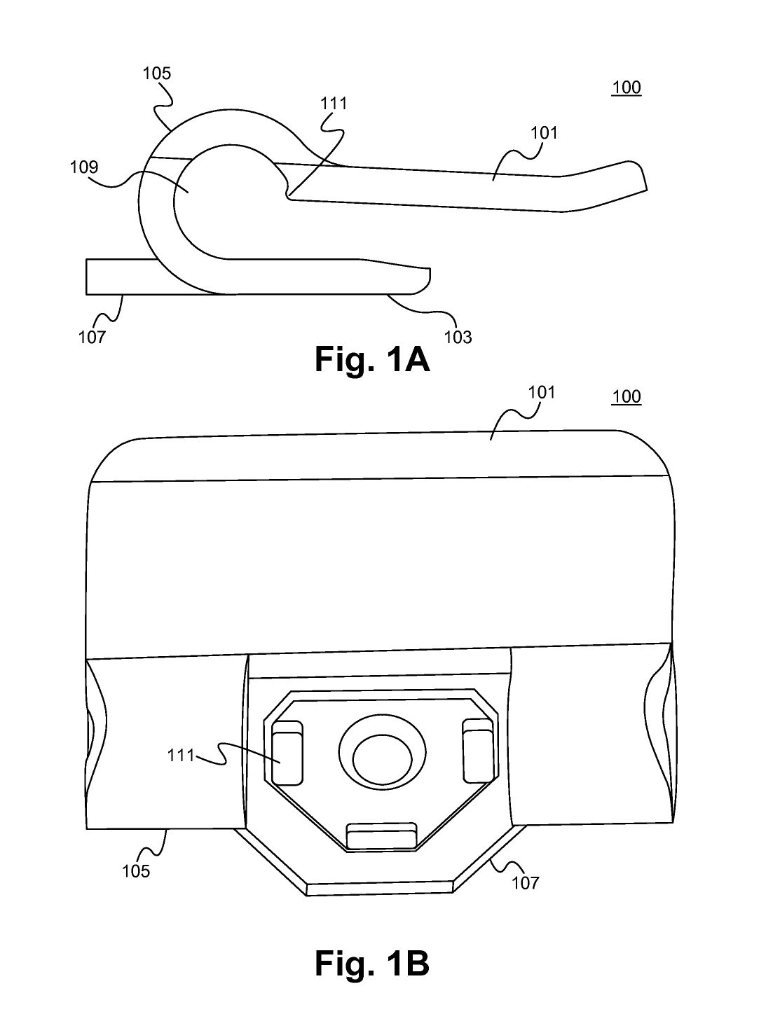

Referring now to FIG. 1A, a mounting clip for a watering mat is depicted therein. In some embodiments, the mounting clip 100 is configured to couple with and secure a watering mat such as described within the co-owned patent application Ser. No. 13/914,454, and entitled COMPOSITE MAT FOR WATER DISTRIBUTION AND SELF-WATERING OF POTTED PLANTS, which is hereby incorporated by reference, to an additional object. For example, in some embodiments, the mounting clip 100 is configured to mount the watering mat to an object such as a table, the ground or other surface where the watering mat is utilized. The mounting clip 100 comprises a mounting clip body comprising a top 101, a bottom 103, and a sidewall 105 connecting the top 101 and the bottom 103. The mounting clip 100 also comprises one or more mounting features 107 for coupling the clip 100 and a watering mat with an object.

As shown within FIG. 1A, the sidewall 105 comprises a curved surface between the top 101 and the bottom 103. A rounded opening 109 between the top 101 and the bottom 103 fits over an edge of a watering mat. In some embodiments, the opening 109 comprises a hook feature 111 for hooking the clip 100 on an edge of a watering mat for securely coupling the mounting clip 100 with the watering mat. In some embodiments, when the clip 100 is coupled with the watering mat, the top 101 is flush with a top edge of the mat and the bottom 103 fits on the underside of the mat. Particularly, the top 101 comprises a smooth low profile top in order to securely fit on the mat. The profile of the clip 100 is configured to match the profile of a watering mat edge binding in order to create a secure hold.

As shown within FIG. 1B, the one or more mounting features 107 comprise one or more mounting holes 111. In some embodiments, the one or more mounting holes 111 are configured to receive one or more of a screw, a nail, and one or zip-ties which couple the clip 100 to an object. The mounting clip 100 is configured to receive the watering mat and securely couple the watering mat to an object, such as a a table, the ground or other surface where the watering mat is utilized, as described above. Particularly, the opening 109 surrounds and holds an edge of the watering mat. With the clip 100 in place the watering mat is coupled to the object. In this manner, the clip 100 securely holds the watering mat in place so that it is easily used and does not move. In some embodiments, a plurality of clips 100 can be utilized in order to hold a watering mat in place.

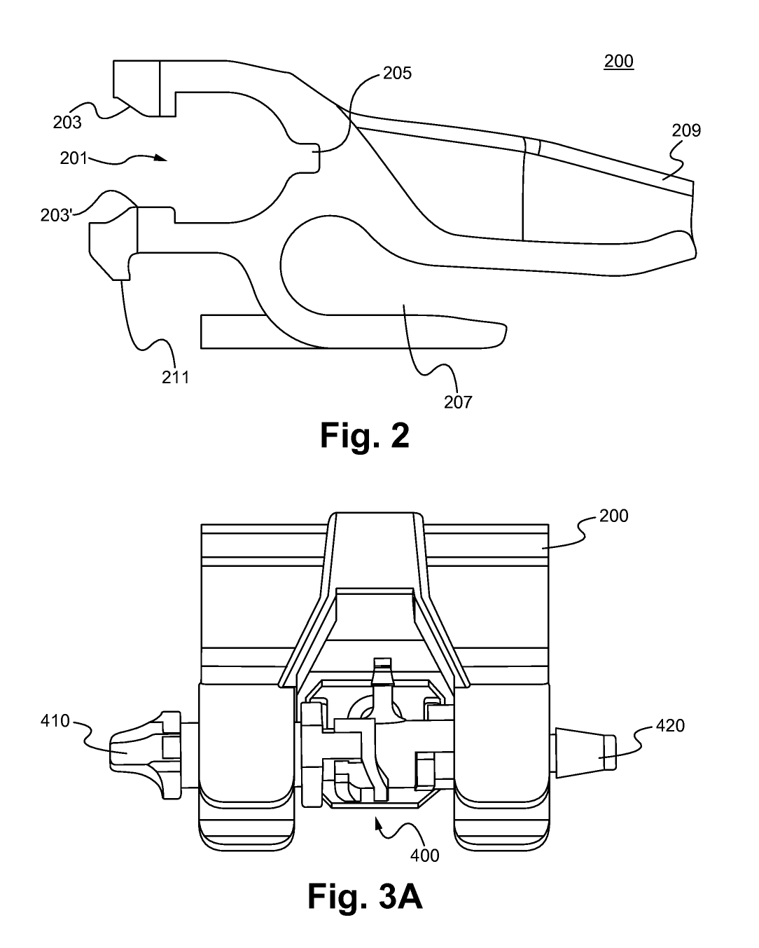

FIG. 2 illustrates a side view of an injector device for a watering assembly. The injector device 200 is configured to hold an emitter (300) at an area so that it is able to water a selected area. In some embodiments, the injector device 200 comprises a snap jaw 201 for releasably receiving an emitter body and a clip 207 for clipping the injector device 200 to a watering area. In some embodiments, the injector device 200 also comprises a mounting clip, such as described above. In some embodiments, the emitter is securely held by the snap jaw 201. In some embodiments, the emitter is permanently connected or integrated with the clip. In some embodiments, the snap jaw 201 comprises one or more teeth 203 and 203′ which firmly lock and hold the emitter within the snap jaw. In some embodiments, the injector device 200 also comprises a torque slot 205 which prevents the emitter from twisting when it is held by the injector clip 200. In some embodiments a hood 209 protects an injector tube and/or a needle of the emitter. In some embodiments, the injector device 200 is configured to couple the emitter with an edge of a watering mat, such as described above.

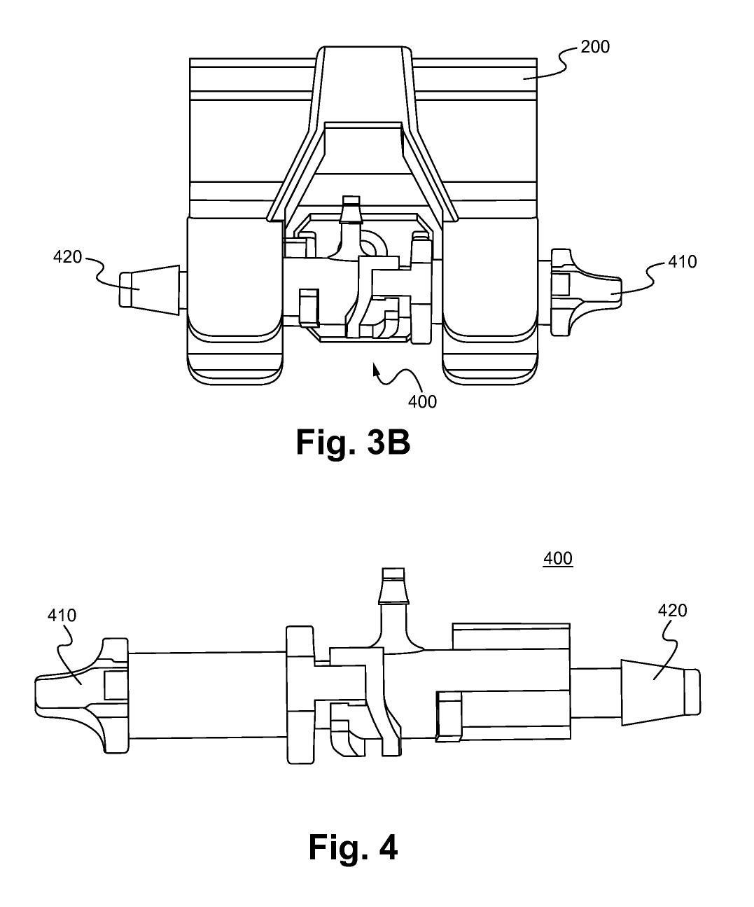

As shown within FIG. 3A and 3B, an emitter body 400 is reversible within the snap jaw 401 of the injector clip 200. Particularly, the emitter body 400 is able to couple with the injector clip so that a flow restrictor 410 and housing 420 are able to face either direction. Consequently, the emitter is able to deliver water to an area on a first side and a second side of an injector clip 200. In some embodiments, the watering area comprises a first watering mat. In some embodiments, the injector clip 300 comprises a rear hook feature 211 for securing the injector device to a second watering mat.

FIG. 4A illustrates an emitter assembly configured to couple with the injector clip 200, such as described above. As described above, the emitter assembly comprises an emitter body 400 comprising an adjustable flow restrictor 410 and a housing 420. The emitter assembly is configured to couple with a waterline in order to deliver water to a specified area.

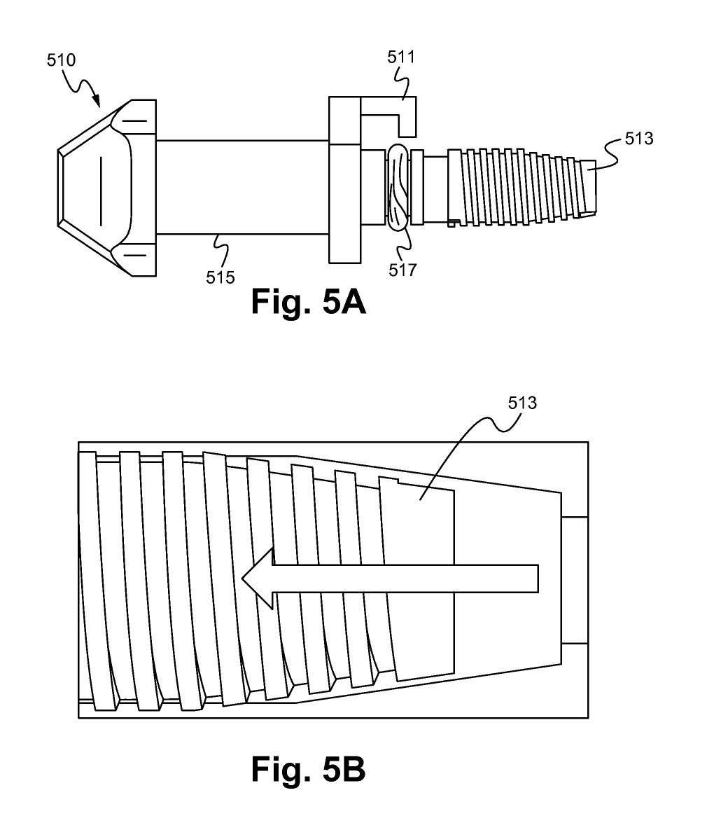

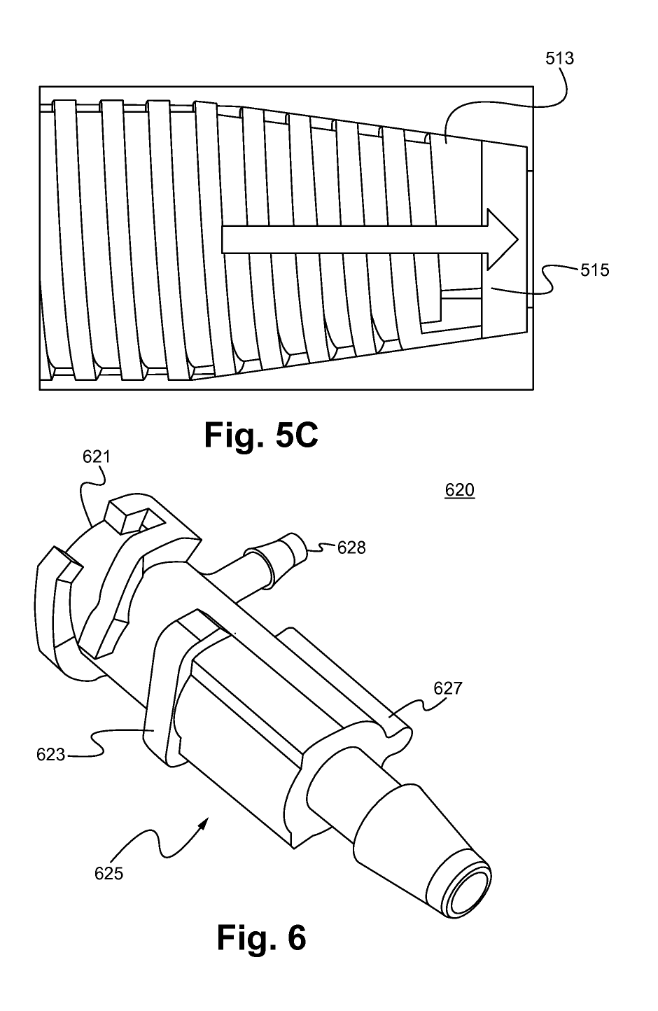

FIG. 5A illustrates a close-up view of an adjustable flow restrictor 510. In some embodiments, the adjustable flow restrictor 510 comprises a clip 511 for securing the flow restrictor 510 within the housing. In some embodiments, the flow restrictor 510 also comprises an o-ring 517 in order to ensure a water-tight fit with the housing. The flow restrictor 510 is removably coupled with an injector clip by placing a snap jaw over a middle section 515 of the flow restrictor 510. The snap jaw loosely holds the middle section 515 so that the flow restrictor 510 is still able to be rotated. As described above, in some embodiments, the flow restrictor 510 is permanently connected or integrated with the clip.

A tapered flow segment 513 provides a helical water flow path which is able to reduce water flow rate. The helical water flow path is partially tapered which allows a water flow rate to be adjusted by moving the flow restrictor 510 axially forward and backward with respect to the housing. In some embodiments, other flow paths including grooves or zig-zags are included within the tapered flow segment. In some embodiments, the flow restrictor 510 can be turned in order to adjust the water flow rate between off, 2 GPH and 4 GPH. In some embodiments, the flow restrictor 510 is scaled or adjusted for other flow ranges. In some embodiments, the flow restrictor 510 has an infinite range or adjustability between the off, low and high settings, rather than the three distinct stop positions. FIG. 5B illustrates the flow restrictor 510 adjusted to a high flow configuration. In this configuration, the tapered flow segment 513 can be bypassed for an unimpeded water flow. Alternatively, as shown within FIG. 5C, the flow restrictor 510 is turned so that the tapered flow segment 513 is pressed against a housing wall 515 and forces water to pass through the entire flow segment 513, slowing the flow of water.

FIG. 6 illustrates a close-up view of the emitter assembly housing. The housing 620 comprises a slot 621 for inserting and retaining the adjustable flow restrictor 520, a slide top 623 to keep the emitter assembly centered when it is held by the injector clip and a center geometry 625 which is complementary to the shape of the snap jaws and further helps secure the housing 620. In some embodiments, a torque key 627 is configured to fit within the torque slot 205 of the snap jaw 201. As shown within FIG. 6, the housing 620 further comprises one or more barbs 628 for providing a connection to a waterline. For example, in some embodiments, the housing 620 comprises a ⅛ inch line barb for connecting with a ⅛ inch waterline output and a ¼ inch line barb for connecting with a ¼ inch waterline input. Particularly, the housing 620 provides a static location for the one or more barb lines 628.

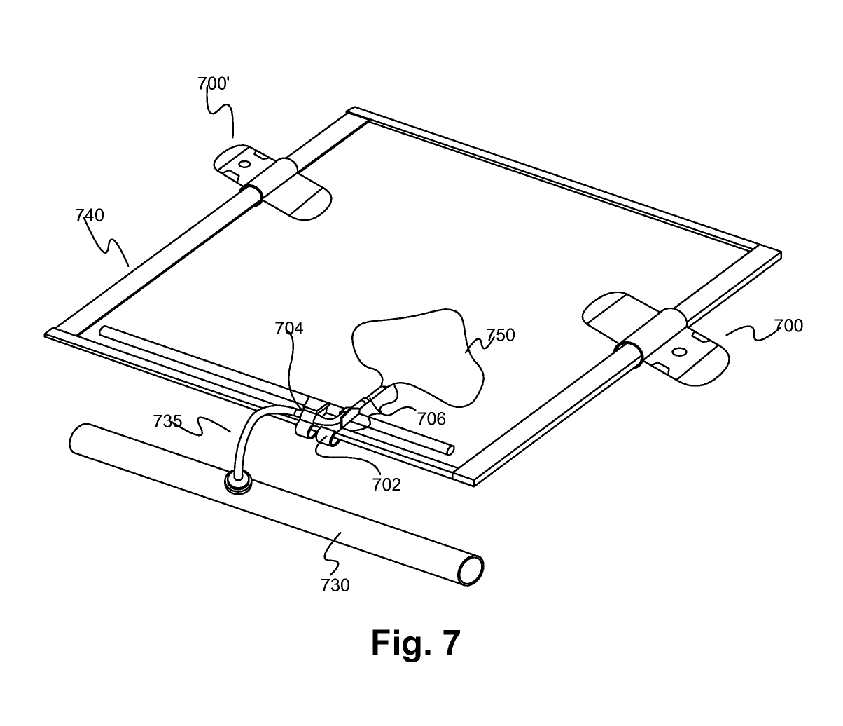

FIG. 7 illustrates a watering assembly in accordance to some embodiments such as described above. The watering assembly comprises one or more waterlines 730, a watering mat 740, one or more clips 700 and 700′ for securing the watering mat 740 in place, an injector device 702 clipped to the watering mat 740 and an injector device 702, which clips to the watering mat 740 and delivers a quantity of water 750 through an emitter end 706 of the emitter assembly 704. In some embodiments, the emitter assembly couples to the one or more waterlines 730 through an emitter line 735. As described above, the emitter assembly 704 is configured to couple with the one or more waterlines 730 in order to deliver water to a specified area. The emitter assembly comprises a water flow restrictor for adjusting the amount of water delivered to the watering mat.

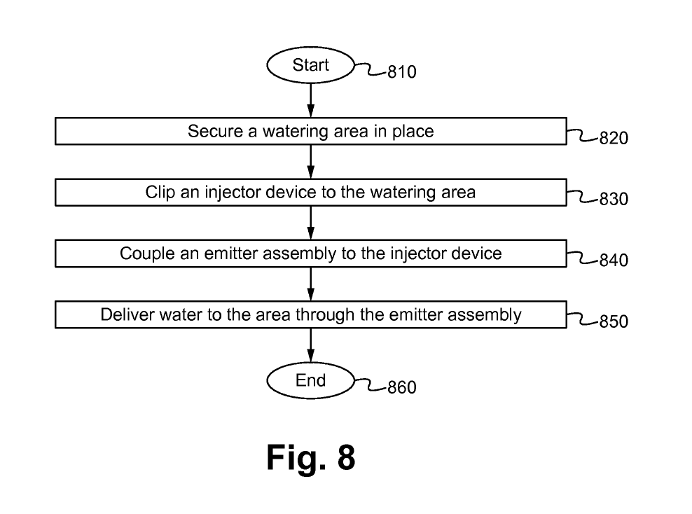

FIG. 8 illustrates a method of watering an area in accordance with some embodiments. The method begins in the step 810. In the step 820, a watering area is secured in place. As described above, in some embodiments, the watering area comprises a watering mat and the watering mat is secured to one of a table, the ground, and a surface for holding the watering mat by one or more mounting features of a mounting clip. Then in, the step 830 an injector device is clipped to the watering area and is coupled with an emitter assembly in the step 840. In the step 850 water is delivered to the area through the emitter assembly. In some embodiments, the method comprises adjusting the amount of water delivered to the watering mat. The method ends in the step 860.

In operation, the integrated clip secures a watering area such as a watering mat in place so that it is not inadvertently moved or otherwise displaced. With the watering mat securely held in place, an injector clip and emitter deliver an adjustable quantity of water to the area. The injector clip holds the emitter at a location on the mat so that water is delivered to a desired area. The amount of water delivered to the area is adjustable between a high flow and a low flow so that the precise amount of water is delivered to the desired area. Accordingly, the integrated clip and injector assembly as described herein has many advantages.

The invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications area able to be made in the embodiment chosen for illustration without departing from the spirit and scope of the invention. Specifically, it will be apparent that the design of the system is able to be implemented in many different styles and configurations. Further, it will be apparent to one of ordinary skill in the art that the precise structure of the device is able to be substantially varied to accommodate various styles of water sources and watering areas. Consequently, the claims should be broadly construed, consistent with the spirit and scope of the invention, and should not be limited to their exact, literal meaning.

1. A mounting clip for securing a watering mat comprising:
a. a clip body for clipping to the watering mat and comprising:
i. a top;
ii. a bottom; and
iii. a side wall connecting the top and the bottom; and
b. one or more mounting features for mounting the clip to an object.

2. The mounting clip of claim 1, wherein the side wall comprises a curved surface between the top and the bottom.

3. The mounting clip of claim 1, wherein the object comprises one of a table, the ground, and a surface for holding the watering mat.

4. The mounting clip of claim 1, wherein the clip comprises a hook feature for securing the clip body to the watering mat.

5. The mounting clip of claim 1, wherein the one or more mounting features comprise one or more mounting holes.

6. The mounting clip of claim 5, wherein the one or mounting holes are configured to receive one or more of a screw, a nail, and a zip-tie.

7. The mounting clip of claim 1, wherein the top comprises a smooth low profile top which is mounted flush with a top of the watering mat.

8-24. (canceled)

25. A mounting clip for securing a watering mat and holding an injector device comprising:
a. a clip body for clipping to the watering mat and holding the injector device, the clip body comprising:
i. a first clip device for securing the clip body to the watering mat; and
ii. a second clip device for holding the injector device; and
b. one or more mounting features for mounting the clip to an object.

26. The mounting clip of claim 25 wherein the injector device provides water to the watering mat.

27. The mounting clip of claim 25, wherein the object comprises one of a table, the ground, and a surface for holding the watering mat.

28. The mounting clip of claim 25, wherein the first clip device comprises a hook feature for securing the clip body to the watering mat.

29. The mounting clip of claim 25, wherein the one or more mounting features comprise one or more mounting holes.

30. The mounting clip of claim 29, wherein the one or mounting holes are configured to receive one or more of a screw, a nail, and a zip-tie.

31. A mounting clip for securing a watering mat comprising:
a. a clip body for clipping to the watering mat and comprising:
i. a top;
ii. a bottom;
iii. a side wall connecting the top and the bottom; and
iv. a hook feature for securing the clip body to the watering mat; and
b. one or more mounting holes for mounting the clip to an object.

32. The mounting clip of claim 31, wherein the side wall comprises a curved surface between the top and the bottom.

33. The mounting clip of claim 31, wherein the object comprises one of a table, the ground, and a surface for holding the watering mat.

34. The mounting clip of claim 31, wherein the one or mounting holes are configured to receive one or more of a screw, a nail, and a zip-tie.

35. The mounting clip of claim 31, wherein the top comprises a smooth low profile top which is mounted flush with a top of the watering mat.
